(19) United States
(12) Patent Application Publication
(10) Pub. No.: US 2015/0254291 A1
(43) Pub. Date: Sep. 10, 2015

(54) GENERATING AN INDEX OF SOCIAL HEALTH

(71) Applicant: FMR LLC, Boston, MA (US)

(72) Inventors: Ronald Raikula, Boston, MA (US); Megan Kelley, Boston, MA (US)

(73) Assignee: FMR LLC, Boston, MA (US)

(21) Appl. No.: 14/199,654

(22) Filed: Mar. 6, 2014

(51) Int. Cl. G06F 17/30

(52) U.S. Cl. CPC G06F 17/30321

(57) ABSTRACT

Methods and apparatuses are described for generating an index of social health. A server computing device receives social media data from a plurality of social media sources, the social media data associated with a plurality of companies. The server computing device determines, for each of the plurality of companies, one or more dimensions of the social media data based upon the received social media data. The server computing device generates an index score for each of the plurality of companies based upon the one or more dimensions for the company. The server computing device identifies one or more trends associated with the index score for each of the plurality of companies. The server computing device generates a social media health index for an industry by aggregating the index scores for the plurality of companies.

### FIELD OF THE INVENTION

This application relates generally to methods and apparatuses, including computer program products, for generating an index of social health for companies, business segments, and markets.

### BACKGROUND

Social media can be a useful tool for companies to determine characteristics of their business, such as consumer sentiment, product or brand influence, size and influence of their consumer base, and business potential. However, existing methods and models used to determine these characteristics from social media networks typically rely on a limited range of available data from sites such as Facebook and Twitter.

Further, it is difficult for companies to evaluate their recent performance using the social media context to determine trends, especially as related to other companies in their sector or industry, or in the marketplace as a whole. The determination of such trends can be useful to analyze business potential going forward and to predict future performance.

### SUMMARY OF THE INVENTION

Therefore, methods and systems are needed to generate an index of social health by leveraging the rich and complex information resource of social media networks and corresponding interactions. The invention, in one aspect, features a computerized method for generating an index of social health. A server computing device receives social media data from a plurality of social media sources, the social media data associated with a plurality of companies. The server computing device determines, for each of the plurality of companies, one or more dimensions of the social media data based upon the received social media data. The server computing device generates an index score for each of the plurality of companies based upon the one or more dimensions for the company. The server computing device identifies one or more trends associated with the index score for each of the plurality of companies. The server computing device generates a social media health index for an industry by aggregating the index scores for the plurality of companies.

The invention, in another aspect, features a system for generating an index of social health. The system includes a server computing device configured to receive social media data from a plurality of social media sources, the social media data associated with a plurality of companies. The server computing device is configured to determine, for each of the plurality of companies, one or more dimensions of the social media data based upon the received social media data. The server computing device is configured to generate an index score for each of the plurality of companies based upon the one or more dimensions for the company. The server computing device is configured to identify one or more trends associated with the index score for each of the plurality of companies. The server computing device is configured to generate a social media health index for an industry by aggregating the index scores for the plurality of companies.

The invention, in another aspect, features a computer program product, tangibly embodied in a computer readable storage medium, for generating an index of social health. The computer program product includes instructions operable to cause a server computing device to receive social media data from a plurality of social media sources, the social media data associated with a plurality of companies. The computer program product includes instructions operable to cause the server computing device to determine, for each of the plurality of companies, one or more dimensions of the social media data based upon the received social media data. The computer program product includes instructions operable to cause the server computing device to generate an index score for each of the plurality of companies based upon the one or more dimensions for the company. The computer program product includes instructions operable to cause the server computing device to identify one or more trends associated with the index score for each of the plurality of companies. The computer program product includes instructions operable to cause the server computing device to generate a social media health index for an industry by aggregating the index scores for the plurality of companies.

Any of the above aspects can include one or more of the following features. In some embodiments, the dimensions include a volume, a sentiment, a velocity, an audience size, an audience influence, and an audience affluence. In some embodiments, the server computing device annotates the received social media data, where the annotations correspond to the one or more dimensions.

In some embodiments, the step of generating an index score further includes receiving, by the server computing device, a set of tuning data for each of the plurality of companies, the tuning data including (i) general economic condition data, (ii) fundamentals for the company, (iii) weight values assigned to each of the plurality of social media sources, and (iv) aggregated social media influence and affluence data associated with customers of the company, and synthesizing, by the server computing device, the dimensions of the social media data and the received tuning data to generate the index score.

In some embodiments, the weight values are adjusted based upon machine learning. In some embodiments, the weight values are assigned by an investment analyst. In some embodiments, an identity of one or more customers of at least one of the companies across the social media sources is determined based upon the synthesized data.

In some embodiments, the step of identifying one or more trends further includes comparing, by the server computing device, the dimensions of the social media data for a company with historical values for the dimensions, and determining, by the server computing device, a change in at least one of the dimensions. In some embodiments, the server computing device generates a revised index score for the company based upon the change in at least one of the dimensions.

In some embodiments, the revised index score is compared with the index score for a second company to determine performance of the company with respect to the second company. In some embodiments, the revised index score is compared with an industry benchmark to determine performance of the company with respect to the industry. In some embodiments, the server computing device publishes the generated index score on a data feed for consumption by other computing devices.

In some embodiments, the one or more trends are indexed based upon a set of preferences associated with a financial analyst. In some embodiments, the indexed one or more trends are analyzed to determine correlations between the one or more trends, divergences in the one or more trends, inflection points in the one or more trends, thresholds in the one or more trends, or weights of the one or more trends. In some embodiments, the dimensions include a volume, a sentiment, a velocity, an audience size, an audience influence, and an audience affluence.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for generating an index of social health.

FIG. 2 is a detailed block diagram of a system for generating an index of social health.

FIG. 3 is a flow diagram of a method for generating an index of social health.

FIG. 4 is a block diagram of a system for determining an affluence and influence score for individuals that are represented in social media data.

FIG. 5 is a block diagram of a networked system for generating an index of social health.

### DETAILED DESCRIPTION

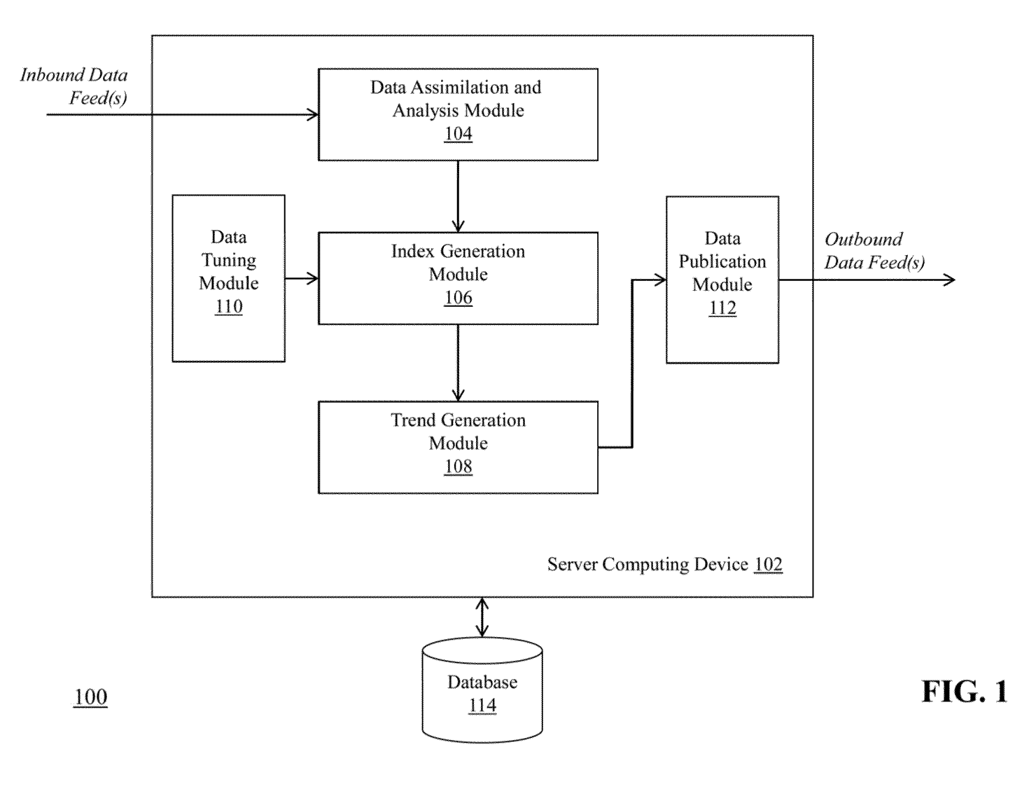

FIG. 1 is a block diagram of a system 100 for generating an index of social health. The system 100 includes a server computing device 102 that executes a number of modules 104, 106, 108, 110 and 112, and a database 114 that is coupled to the server computing device 102. The computing device and related modules implement the computer processing in accordance with computer-implemented embodiments of the invention. The methods described herein may be achieved by implementing program procedures, modules and/or software executed on, for example, a processor-based computing devices or network of computing devices.

The server computing device 102 includes network-interface components to connect to a communications network (not shown). In some embodiments, the network-interface components include components to connect to a wireless network, such as a Wi-Fi or cellular network, in order to access a wider network, such as the Internet.

The communications network sends communications from the server computing device 102 and to other computing devices coupled to the server computing device 102, as will be described in greater detail below. The network may be a local network, such as a LAN, or a wide area network, such as the Internet and/or a cellular network.

The server computing device 102 receives inbound data feed(s) from various external resources, such as other computing devices, networks, databases, and the like. The server computing device 102 also transmits outbound data feed(s) to various external resources.

The server computing device 102 includes a data assimilation and analysis module 104, an index generation module 106, a trend generation module 108, a data tuning module 110, and a data publication module 112. The modules 104, 106, 108, 110 and 112 are hardware and/or software modules located in the server computing device 102 and used to execute the method for generating an index of social health as described herein. In some embodiments, the functionality of the modules 104, 106, 108, 110 and 112 is distributed among a plurality of computing devices. It should be appreciated that any number of computing devices, arranged in a variety of architectures, resources, and configurations (e.g., cluster computing, virtual computing, cloud computing) can be used without departing from the scope of the invention.

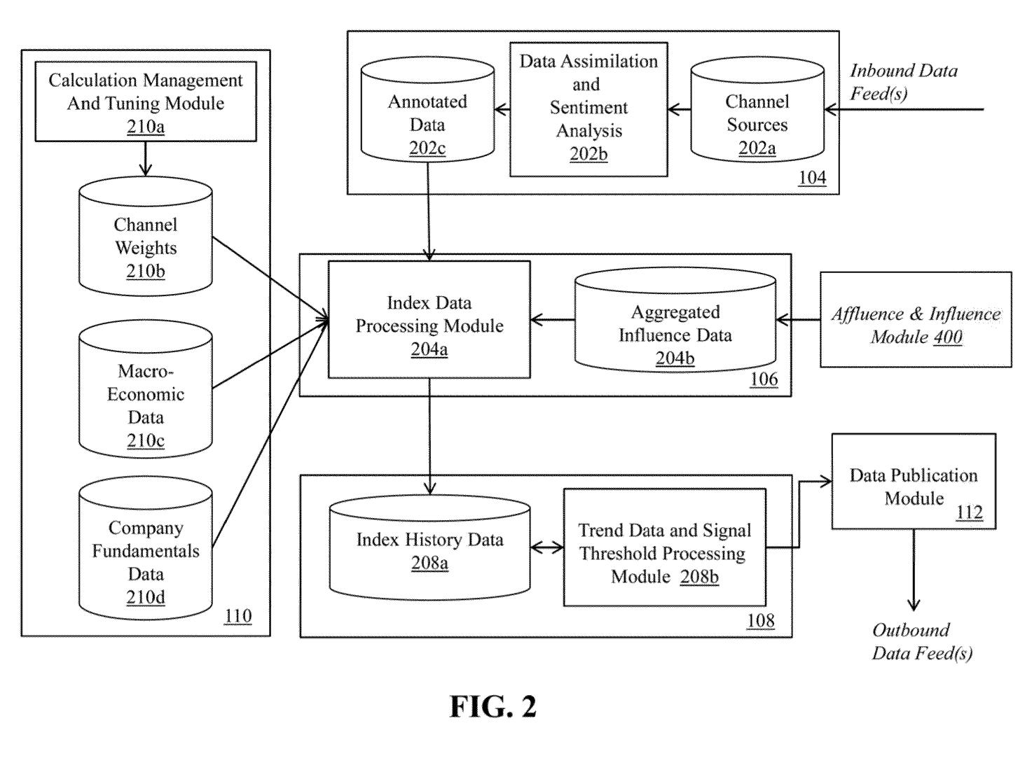

The database 114 is coupled to the server computing device 106 (e.g., via a communications network), and stores data associated with the generation of the index of social health. In some embodiments, the database 114 resides on a separate computing device from the server computing device 102. In some embodiments, the database 114 is integrated into the server computing device 102. Although FIG. 1 depicts a single database 114, it should be appreciated that multiple databases can be used without departing from the scope of the invention. As will be described in greater detail with respect to FIG. 2, the database can store a variety of data for each of the modules 104, 106, 108, 110 and 112.

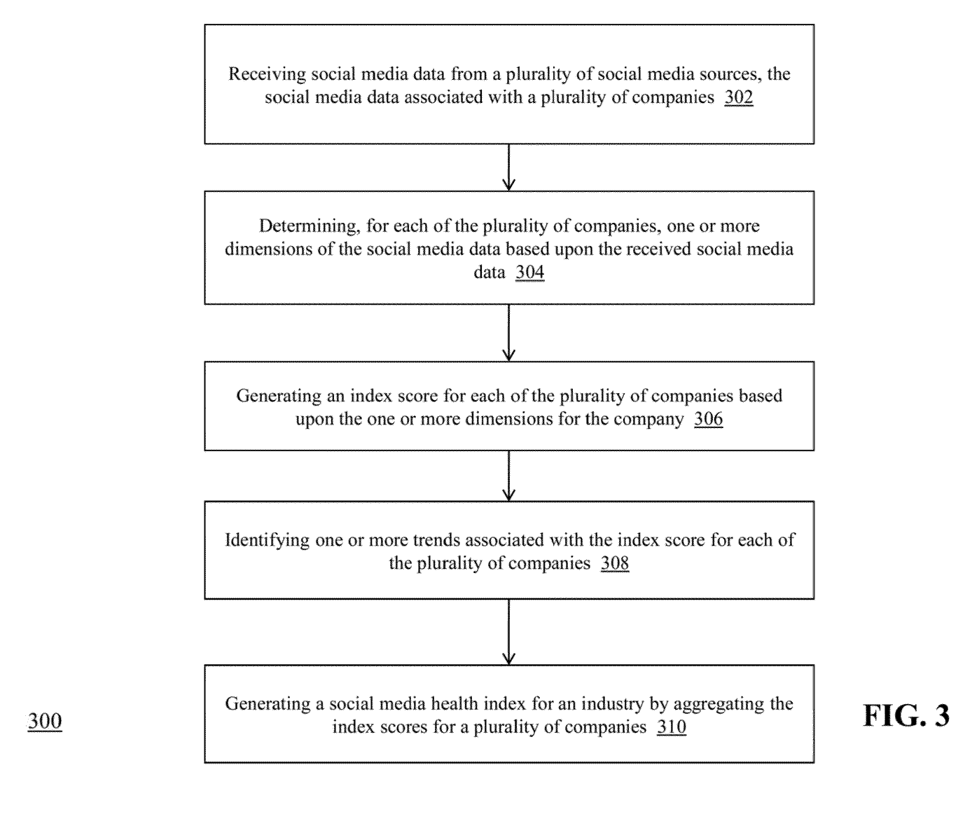

FIG. 2 is a detailed block diagram of the system of FIG. 1 for generating an index of social health. As shown in FIG. 2, the data assimilation and analysis module 104 includes a channel sources database 202a, a data assimilation and sentiment analysis module 202b, and an annotated data database 202c. The index generation module 106 includes an index data processing module 204a and an aggregated influence data database 204b. The trend generation module 108 includes an index history data database 208a and a trend data and signal threshold processing module 208b. The data tuning module 110 includes a calculation management and tuning module 210a, a channel weights database 210b, a macro-economic data database 210c, and a company fundamentals data database 210d. Each of these modules and databases will be described in greater detail below with respect to FIG. 3.

FIG. 3 is a flow diagram of a method 300 for generating an index of social health, using the system 100 depicted in FIGS. 1 and 2. The server computing device 102 receives (302) social media data from a plurality of social media sources, the social media data associated with a plurality of companies. The data assimilation and analysis module 104 receives data from a variety of social media sources and platforms, including but not limited to social networking sites (such as Facebook, LinkedIn, and Twitter), blogs, photos, location services sites (such as

Foursquare), and other types of social media data sources. The data can be in the form of social media interactions (e.g., ‘likes’, ‘tweets’, ‘posts’, ‘follows’). The incoming social media data is associated with companies, i.e., corporations and other businesses. In some embodiments, the incoming social media data is associated with other types of organizations. It should be appreciated that the system can receive social media data form any number of different types of entities that utilize social networks.

The channel sources database 202a receives the incoming social media data and stores it for retrieval and processing by the data assimilation and sentiment analysis module 202b. The data assimilation and sentiment analysis module 202b processes the social media data to, e.g., identify the volume and quality of activity represented in the data. For example, the module 202b evaluates interactions associated with a particular company (e.g., Fidelity Investments) and to determine a total volume of interactions for that company. The module 202b can also determine a sentiment for the interactions, such as positive, negative, or neutral. The module 202b can also determine whether certain types of interactions are happening concurrently, such as a social media user tweeting about Fidelity while at the same time ‘checking in’ at a Fidelity branch, or a user posting a picture of Fidelity's logo on their Facebook page. The module 202b can also determine the geographical scope associated with the social media data, such as region (i.e., New England), state, country, zip code and the like. The module 202b can further determine a ‘virality’ of the interactions, that is, a velocity and a directionality of interactions within a defined time period (e.g., how many shares/retweets occurred in a certain period of time and/or how widespread were the interactions within social media networks, in between different social media networks, and the like).

In some embodiments, the data assimilation and sentiment analysis module 202b individualizes and then anonymizes the interaction data to ensure that, as a social health index is generated, the individual social media participants are not identifiable to the recipients of the social media health data.

The server computing device 102 determines (304), for each of the plurality of companies, one or more dimensions of the social media data based upon the received social media data. The module 202b annotates the social media data according to one or more dimensions identified via its analysis. For example, if the module 202b determines that a social media interaction is positive, the module 202b can assign a dimension (e.g., a piece of metadata) to the interaction, such as tagging or categorizing the interaction as positive. Other types of dimensions or metadata attributable to the interaction can include location, date/time, originating user identity, user demographics, company identity, subject matter, the inclusion of links to other resources/sites, secondary interactions (e.g., likes, retweets, favorites, shares), language translation, image recognition, among other things. The module 202b stores the annotated social media interaction in the annotated data database 202c.

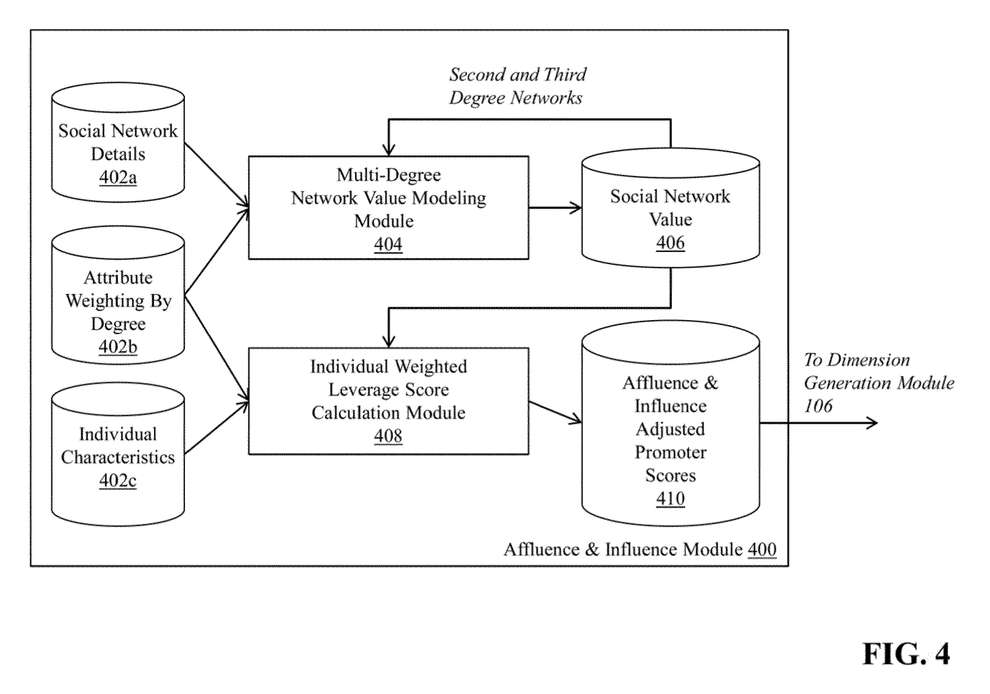

The server computing device 102 generates (306) an index score for each of the plurality of companies based upon the one or more dimensions for the company. The index data processing module 204a of the index generation module 106 retrieves the annotated social media interaction data from the annotated data database 202c and processes the data to aggregate and weigh the data in terms of the characteristics represented in the metadata described above. The index data processing module 204a analyzes the annotated data within a broader context of data sources, such as those provided by the data tuning module 110 and the affluence & influence module 400 of FIG. 4. The module 204a evaluates the annotated data via a weighting process, where the module 204a weighs different dimensions associated with the annotated data, and factors in the broader context data, to generate a social media index score associated with the company. The social media index score can be temporal in nature, that is, the score can be calculated for a particular time period (e.g., one week, one month, six months, one year). The module 204a can periodically recalculate or refresh the score.

For example, the module 204a receives the annotated data associated with Fidelity Investments and determines various component signals for the data based upon a weighting algorithm provided by the data tuning module 110. In one example, the module 204a determines that there has been an increase in the volume of positive interactions associated with Fidelity during a particular time period (e.g., last month)—a first component signal. The module 204a also determines that there has been an increase in the number of photos posted to social media sites that include the Fidelity brand name and/or logo—a second component signal. The module 204a also determines that there has been an increase in check-in traffic for users at Fidelity locations—a third component signal. The module 204a then determines an index score for Fidelity by weighing each of the component signals according to a predetermined algorithm.

For example, the calculation management and tuning module 210a of the data tuning module 110 stores a weighting algorithm for a broad category of companies, such as financial investment companies. The weighting algorithm assigns a particular weight score to different types of social media interactions, social media networks, and/or dimensions of the annotated social media data as identified by the module 204a. In some embodiments, the module 210a can further adjust the weighting algorithm based upon input from another computing device, e.g., a financial analyst's system.

The module 210a transmits the weighting algorithm to the channel weights database 210b for storage. For example, the channel weights database 210b can store a weighting algorithm for specific companies (e.g., Fidelity) as well as broader categories of companies (e.g., sectors, industries). The index data processing module 204a retrieves one or more weighting algorithms from the channel weights database 210b and determines an index score for a company by inputting the annotated data and/or the component signal data into the weighting algorithm.

In addition, the index data processing module 204a can receive other types of data from the data tuning module 110 for use in determining the index score. The module 204a can retrieve general economy and/or industry data from the macro-economic data database 210c. Such data includes, but is not limited to, employment data, consumer price index (CPI) & gross domestic product (GDP) data, market indices, currency data, and the like. The macro-economic data can be associated with the U.S. economy and/or other foreign national or regional economies. The module 204a can use the macro-economic data to determine how a company's social media index score compares to general economic trends, or to adjust the company's social media index score based upon such trends.

The module 204a can retrieve company fundamentals data from the company fundamentals database 210d. Such data includes, but is not limited to, balance sheet information, income statement, cash flow, management structure, return on assets, and the like. The module 204a can use the company fundamentals data to determine how a company's social media index score compares to trends in the company's fundamentals (or those of its competitors), or to adjust the company's index score based upon such trends.

The index data processing module 204a also receives data from the affluence and influence module 400 of FIG. 4 via the aggregated influence data database 204b. As will be described in greater detail below, the affluence and influence module 400 determines the relative affluence and influence of the users (and their corresponding primary, secondary, and tertiary social media networks) that generated or contributed to the social media interactions received by the data assimilation and sentiment analysis module 202b (as described previously).

Another aspect of the module 204a is to determine the identity of users across social media networks and use the identity in conjunction with the data received from the affluence and influence module 400. For example, the module 204a determines that User A on Facebook is the same person as User B on Twitter. The module 204a can evaluate the annotated social media interaction data in conjunction with user identity and the affluence and influence data to adjust a company's social media index score. For example, if the identified user is a renowned celebrity and has social media profiles with several million followers, and who has posted several positive tweets about Fidelity, the module 204a can, e.g., increase the company's social media index score to account for the high-profile and potentially far-reaching interactions.

Once the module 204a has determined the company's social media index score, the module 204a stores the index score in the index history data database 208a. The index history data database 208a contains a historical compilation of company indexes for prior periods of time. For example, the database 208a can store social media index scores for Fidelity Investments, as calculated by the module 204a for specific periods (e.g., weekly, monthly, yearly).

The server computing device 102 identifies (308) one or more trends associated with the index score for each of the plurality of companies, and generates (310) a social media health index for an industry by aggregating the index scores for a plurality of companies. The trend data and signal threshold processing module 208b of the trend generation module 108 retrieves index scores from the database 208a and evaluates the index scores to determine trends occurring in the data, both on a company-specific level and a broader sector/industry/competitor level. The module 208b can aggregate individual company social media scores into an aggregate sector-based or industry-based health index, similar to financial indices such as NASDAQ or S&P 500. And, the temporal nature of the social media index score enables the module 208b to compare prior index scores for a particular company/sector/industry to current index scores to understand and analyze the cause(s) behind changes to the index scores.

In one example, the module 208b can compare the social media index score for a company on a month-to-month basis for the last year to determine changes (e.g., increases, decreases, plateaus, inflection points) in the index score and correlate the index score to external data or activity (e.g., a new product launch, a CEO's departure, general economic trends, a competitor's activity). For example, if a company's social media index score increased by 5% from month one to month two, the module 208b can evaluate the overall sector's social media index score for the same time period and determine how the company is performing in a social media context relative to the entire sector. If, for example, the entire sector's social media score decreased by 10%, the module 208b can determine that the company is outperforming its peers from a social media perspective.

In another example, the module 208b can determine trends in competitor-to-competitor activity. For example, the module 208b can compare Fidelity's social media index score for the year 2013 against Charles Schwab's social media index score for the same time period. If Fidelity's social media index score is higher over that period than Schwab's score, then the module 208b can determine that Fidelity is experiencing a greater social media presence or impact than Schwab.

In another example, the module 208b can compare a company's social media index score to other external data, such as marketing activity, financial reporting activity and the like (e.g., data retrieved from the data tuning module 110). For example, Fidelity's social media index score increased by 20% shortly after a new marketing campaign was implemented. The module 208b can analyze the underling interaction data that supported the score increase to determine whether the marketing campaign had a direct impact on the social media score (e.g., more positive interactions that identify the marketing campaign, more shares of a YouTube video with the marketing campaign commercial, more photos of marketing campaign posters being uploaded to Instagram, and so forth).

The trend data and signal threshold processing module 208b also transmits the index score and trend data to a data publication module 112. The data publication module 112 makes the index score and trend data available for consumption by remote computing devices (e.g., via a data feed and/or subscription methodology). For example, a research analyst at a mutual fund broker can subscribe to the social media index data feed for a particular company and/or sector to use the data in evaluating company performance for investment purposes. Such external users can also access the underlying social media interaction data and/or component signal data to perform more complex queries and analyses. For example, the user can supply the system 100 with a customized weighting algorithm to generate an index score or trend analysis that is specific to his or her requirements (e.g., what component signals should be emphasized or diminished, what social media network interaction data should be excluded or included, what external economic/company/financial data should be used, what time period(s) should be evaluated). In another example, the user (e.g., an analyst) can set signal thresholds for trend inflection points or magnitude to receive a customized view of the social media health index and interaction data.

As described above, one aspect of data that is used by the system 100 to generate a social media health index score is affluence and influence data of users that generate and/or contribute to the inbound social media interaction data, and the secondary social media networks of those users. A user's affluence and influence can have a considerable impact on the social media health index score for a particular company. For example, a high-affluence user may be connected to other high-affluence users, and a social media interaction generated by that high-affluence user can have a greater impact for a particular company than a social media interaction generated by a lower-affluence user. As an example, Fidelity Investments and other similar financial services companies may be interested in increasing brand awareness and services awareness among high-affluence individuals. If a high-affluence individual generates social media interactions that involve Fidelity that are received by other high-affluence individuals, the activity can have a positive impact on the social media health of Fidelity by directly connecting Fidelity to individuals that Fidelity is seeking as customers.

In another example, a high-influence user (e.g., a celebrity) may be connected to a large volume of other social media users, and a social media interaction generated by that high-influence user can have a greater impact for a particular company than a social media interaction generated by a lower-influence user. As an example, a high-influence user generates a social media interaction that mentions a soft drink company, the interaction can have a positive impact on the social media health of the soft drink company by distributing brand awareness and potential ‘prestige’ of the brand to a large number of other users.

FIG. 4 is a block diagram of a system for determining an affluence and influence score for individuals that are represented in social media data. The system includes an affluence and influence module 400 that contains a social network details database 402a, an attribute weighting by degree database 402b, an individual characteristics database 402c, a multi-degree network value modeling module 404, a social network value database 406, an individual weighted leverage score calculation module 408, and an affluence and influence adjusted promoter scores database 410.

The social network details database 402a receives and stores data associated with the identity of the primary, secondary and tertiary connections to an individual social media user, including but not limited to demographic information, age, location, education, job title, career path, secondary network size (e.g., number of followers, number of friends, and so forth). For example, the database 402a stores data that associates a particular social media user with his or her connections to create a mesh of connections among the social media users.

The attribute weighting by degree database 402b stores weights for the data relating to the social media users as described in the previous paragraph. For example, the database 402b contains a matrix of weights to be applied to the social media user data as the data is processed by the multi-degree network value modeling module 404, as described in greater detail below.

The individual characteristics database 402c stores data associated with the individual social media user, including but not limited to demographic information, age, location, education, job title, career path, primary/secondary/tertiary network size (e.g., number of followers, number of friends, and so forth). The database 402c also includes user data such as net worth (or asset value) and individual promoter score.

The multi-degree network value modeling module 404 receives data from the social network details database 402a and attribute weighting by degree database 402b and determines a network value for the primary, secondary and tertiary social media networks connected to a particular social media user to generate a social media network value score for that user. For example, the module 404 retrieves the social media network data from the database 402a, applies a matrix of weights, as retrieved from the database 402b, to particular components of the social media network data, and generates a social network value for the social media network of a particular user.

As an example, the module 404 determines that job title and net worth of a user's primary, secondary and tertiary contacts should be weighted more than attributes like age and location. The module 404 retrieves the social media network data for each of the connections in a user's primary, secondary, and tertiary social media networks and weighs them according to the predetermined values. The module 404 then determines a value for the user's entire social media network based upon the evaluation of the data. As shown in FIG. 4, the module 404 can leverage calculated values for, e.g., a user's primary connections in order to determine a value for the user's secondary and tertiary connections.

Once the value of the user's social network has been determined, the individual weighted leverage score calculation module 406 determines a leverage score associated with the individual user whose social networks were previously evaluated. The module 406 retrieves demographic, employment, net worth, promoter score, and other types of data associated with the individual user from database 402c, weighs the individual data using a matrix of weights retrieved from database 402b, and determines a leverage score for the individual user. For example, if the individual user is a high-net-worth CEO of a Fortune 500 company with 500 social media connections, the module 406 may assign a higher leverage score to that user than a user who is a freelance photographer with 35 social media connections.

The module 406 applies the leverage score for the individual user to the determined social media network value to generate an affluence and influence adjusted network value score. For example, the high-net-worth CEO's network value score may be increased to account for the CEO's high leverage score, in that the CEO is presumed to have leverage to influence or impact his or her social media connections—making his or her social media network ‘worth’ more (e.g., to companies, potential advertisers, and the like). The module 406 transmits the affluence and influence adjusted network value score, and in some cases, the underlying social media network value information, to the system 100 for incorporation into the process of generating a social media health index for companies.

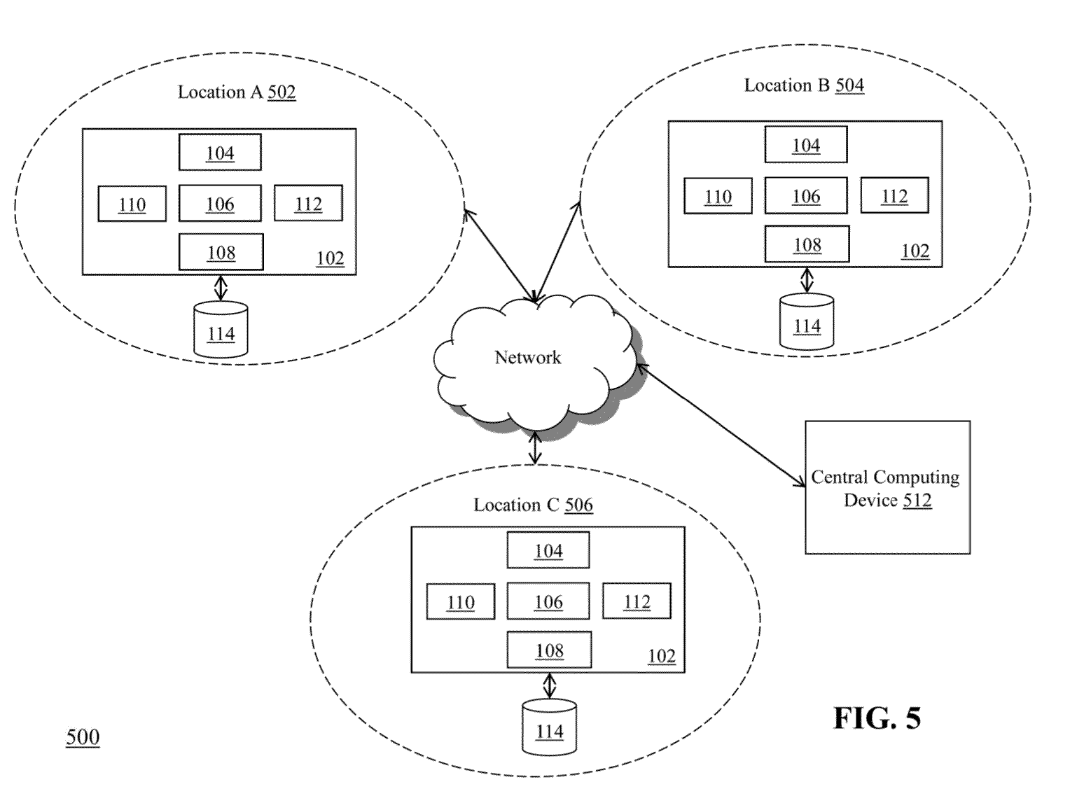

The techniques may be implemented in a networked system 500 comprising multiple computing devices distributed across different locations, as shown in FIG. 5. Each of Location A 502, Location B 504 and Location C 506 includes the server computing device 102 having components 104, 106, 108, 110, 112, 114 of FIGS. 1 and 2, and the servers at locations 502, 504, and 506 are connected to each other via the network. The networked system of FIG. 5 enables distribution of the processing functions described herein across several computing devices and provides redundancy in the event that a computing device at one location is offline or inoperable. In some embodiments, the server computing devices 102 at the respective locations 502, 504, 506 communicate with a central computing device 512 (e.g., a server) that is coupled to the network. The central computing device 512 can provide data and/or processing resources for the network of computing devices 102 (e.g., synchronization of functionality/data across the computing devices).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

1. A computerized method for generating an index of social health, the method comprising:
receiving, by a data assimilation and analysis module executing on a processor of a server computing device, social media interactions from a plurality of social media networks, each social media interaction including social media sharing activity data for the interaction;
determining, by the data assimilation and analysis module, a plurality of companies identified in the social media interactions;
annotating, by the data assimilation and analysis module, for each of the plurality of companies, each social media interaction with a plurality of dimensions based upon the social media sharing activity data, the annotating comprising:
determining a velocity of the social media interaction based upon a volume of sharing activity for the interaction that occurred both within the social media network where the interaction originated and across the plurality of social media networks for a defined time period;
determining a directionality of the social media interaction based upon a dispersal of sharing activity for the interaction both within the social media network where the interaction originated and across the plurality of social media networks for the defined time period; and
modifying the social media interaction to include a reference to the velocity and the directionality;
determining, by an index data processing module executing on the processor of the server computing device, a component signal for each dimension of the social media interaction by identifying a change in the dimension for a particular time period and assigning a weight to each component signal according to a weight matrix provided by a data tuning module executing on the processor of the server computing device;
generating, by the index data processing module, a social media health index score for each of the plurality of companies based upon the component signals;
identifying, by a trend data and signal threshold processing module executing on the processor of the server computing device, one or more trends associated with the social media health index score for each of the plurality of companies; and
generating, by the trend data and signal threshold processing module, a social media health index for an industry by aggregating the social media health index scores for the plurality of companies.

2. The method of claim 1, wherein the annotating step further comprises:
determining one or more of an audience influence and an audience affluence of the social media interaction based upon the velocity and the directionality of the interaction for the defined time period; and
modifying the social media interaction to include a reference to the audience influence and/or the audience affluence.

3. (canceled)

4. The method of claim 1, the step of generating a social media health index score further comprising:
receiving, by the data tuning module, a set of tuning data for each of the plurality of companies, the tuning data including (i) general economic condition data, (ii) fundamentals for the company, (iii) weight values assigned to each of the plurality of social media networks, and (iv) aggregated social media influence and affluence data associated with customers of the company; and
synthesizing, by the data tuning module, the dimensions of the social media interactions, the component signals, and the received tuning data to generate the social media health index score.

5. The method of claim 4, wherein the weight values are adjusted based upon machine learning.

6. The method of claim 4, wherein the weight values are assigned by an investment analyst.

7. The method of claim 4, further comprising determining an identity of one or more customers of at least one of the companies across the social media networks based upon the synthesized data.

8. The method of claim 1, the step of identifying one or more trends further comprising:
comparing, by the trend data and signal threshold processing module, the dimensions of the social media interaction for a company with reference values for the dimensions;
comparing, by the trend data and signal threshold processing module, the component signals with reference values for the component signals; and
determining, by the trend data and signal threshold processing module, a change in at least one of the dimensions or a change in at least one of the component signals.

9. The method of claim 8, further comprising generating, by the index data processing module, a revised social media health index score for the company based upon the change in at least one of the dimensions or the change in at least one of the component signals.

10. The method of claim 9, further comprising comparing the revised social media health index score with a social media health index score for a second company to determine performance of the company with respect to the second company.

11. The method of claim 9, further comprising comparing the revised social media health index score with an industry benchmark to determine performance of the company with respect to the industry.

12. (canceled)

13. The method of claim 1, wherein the one or more trends are indexed based upon a set of preferences associated with a financial analyst.

14. The method of claim 1, wherein the indexed one or more trends are analyzed to determine correlations between the one or more trends, divergences in the one or more trends, inflection points in the one or more trends, thresholds in the one or more trends, or weights of the one or more trends.

15. A system for generating an index of social health, the system comprising a server computing device having a data assimilation and analysis module, a data tuning module, an index data processing module, and a trend data and signal threshold processing module executing on a processor, the system configured to:
receive, by the data assimilation and analysis module, social media interactions from a plurality of social media networks, each social media interaction including social media sharing activity data for the interaction;
determine, by the data assimilation and analysis module, a plurality of companies identified in the social media interactions;
annotate, by the data assimilation and analysis module, for each of the plurality of companies, each social media interaction with a plurality of dimensions based upon the social media sharing activity data, the annotating comprising:
determining a velocity of the social media interaction based upon a volume of sharing activity for the interaction that occurred both within the social media network where the interaction originated and across the plurality of social media networks for a defined time period;
determining a directionality of the social media interaction based upon a dispersal of sharing activity for the interaction both within the social media network where the interaction originated and across the plurality of social media networks for the defined time period; and
modifying the social media interaction to include a reference to the velocity and the directionality;
determine, by the index data processing module, a component signal for each dimension of the social media interaction by identifying a change in the dimension for a particular time period and assigning a weight to each component signal according to a weight matrix provided by the data tuning module;
generate, by the index data processing module, a social media health index score for each of the plurality of companies based upon the component signals;
identify, by the trend data and signal threshold processing module, one or more trends associated with the social media health index score for each of the plurality of companies; and
generate, by the trend data and signal threshold processing module, a social media health index for an industry by aggregating the social media health index scores for the plurality of companies.

16. The system of claim 15, wherein the annotating step further comprises:
determining one or more of an audience influence and an audience affluence of the social media interaction based upon the velocity and the directionality of the interaction for the defined time period; and
modifying the social media interaction to include a reference to the audience influence and/or the audience affluence.

17. (canceled)

18. The system of claim 15, wherein generating a social media health index score further comprises:
receiving a set of tuning data for each of the plurality of companies, the tuning data including (i) general economic condition data, (ii) fundamentals for the company, (iii) weight values assigned to each of the plurality of social media networks, and (iv) aggregated social media influence and affluence data associated with customers of the company; and
synthesizing the dimensions of the social media interactions, the component signals, and the received tuning data to generate the social media health index score.

19. The system of claim 18, wherein the weight values are adjusted based upon machine learning.

20. The system of claim 18, wherein the weight values are assigned by an investment analyst.

21. The system of claim 18, wherein the index data processing module is configured to determine an identity of one or more customers of at least one of the companies across the social media networks based upon the synthesized data.

22. The system of claim 15, wherein identifying one or more trends comprises:
comparing the dimensions of the social media interactions for a company with reference values for the dimensions;
comparing the component signals with reference values for the component signals; and
determining a change in at least one of the dimensions or a change in at least one of the component signals.

23. The system of claim 22, wherein the index data processing module is configured to generate a revised social media health index score for the company based upon the change in at least one of the dimensions or the change in at least one of the component signals.

24. The system of claim 23, wherein the trend data and signal threshold processing module is configured to compare the revised social media health index score with a social media health index score for a second company to determine performance of the company with respect to the second company.

25. The system of claim 23, wherein the trend data and signal threshold processing module is configured to compare the revised social media health index score with an industry benchmark to determine performance of the company with respect to the industry.

26. (canceled)

27. The system of claim 15, wherein the one or more trends are indexed based upon a set of preferences associated with a financial analyst.

28. The system of claim 15, wherein the indexed one or more trends are analyzed to determine correlations between the one or more trends, divergences in the one or more trends, inflection points in the one or more trends, thresholds in the one or more trends, or weights of the one or more trends.

29. A computer program product, tangibly embodied in a non-transitory computer readable storage medium, for generating an index of social health, the computer program product including instructions operable to cause a server computing device having a data assimilation and analysis module, a data tuning module, an index data processing module, and a trend data and signal threshold processing module executing on a processor to:
receive, by the data assimilation and analysis module, social media interactions from a plurality of social media networks, each social media interaction including social media sharing activity data for the interaction;
determine, by the data assimilation and analysis module, a plurality of companies identified in the social media interactions;
annotate, by the data assimilation and analysis module, for each of the plurality of companies, each social media interaction with a plurality of dimensions based upon the social media sharing activity data, the annotating comprising:
determining a velocity of the social media interaction based upon a volume of sharing activity for the interaction that occurred both within the social media network where the interaction originated and across the plurality of social media networks for a defined time period;
determining a directionality of the social media interaction based upon a dispersal of sharing activity for the interaction both within the social media network where the interaction originated and across the plurality of social media networks for the defined time period; and
modifying the social media interaction to include a reference to the velocity and the directionality;
determine, by the index data processing module, a component signal for each dimension of the social media interaction by identifying a change in the dimension for a particular time period and assigning a weight to each component signal according to a weight matrix provided by the data tuning module;
generate, by the index data processing module, a social media health index score for each of the plurality of companies based upon the component signals;
identify, by the trend data and signal threshold processing module, one or more trends associated with the social media health index score for each of the plurality of companies; and
generate, by the trend data and signal threshold processing module, a social media health index for an industry by aggregating the social media health index scores for the plurality of companies.

30. The method of claim 8, wherein the reference values for the component signals are one or more of the following: historical values of the component signals for the company, historical values of the component signals for one or more other companies, the component signals for the company with different weights assigned, and the component signals for one or more other companies with different weights assigned.

31. The method of claim 1, further comprising:
adjusting, by the index data processing module, the weight assigned to one or more of the component signals;
determining, by the index data processing module, a change to the social media health index score resulting from adjusting the weight assigned to one or more of the component signals; and
determining, by the index data processing module, one or more of the component signals that, when the assigned weight is adjusted, have a greater impact on the social media health index score.

32. The system of claim 15, the index data processing module further configured to:
adjust the weight assigned to one or more of the component signals;
determine a change to the social media health index score resulting from adjusting the weight assigned to one or more of the component signals; and
determine one or more of the component signals that, when the assigned weight is adjusted, have a greater impact on the social media health index score.
